(19) United States
(12) Patent Application Publication
(10) Pub. No.: US 2026/0022017 A1
(43) Pub. Date: Jan. 22, 2026

(54) ANODE MATERIAL FOR HIGH-CAPACITY SODIUM-ION BATTERY, PREPARATION METHOD THEREOF, AND BATTERY

(71) Applicant: SHENZHEN JANAENERGY TECHNOLOGY CO., LTD., SHENZHEN (CN)

(72) Inventors: XIAOYANG CHEN, SHENZHEN (CN); YULIANG CAO, SHENZHEN (CN); ALONG ZHAO, SHENZHEN (CN)

(21) Appl. No.: 19/266,452

(22) Filed: Jul. 11, 2025

Related U.S. Application Data
(63) Continuation of application No. PCT/CN2024/071509, filed on Jan. 10, 2024.

(30) Foreign Application Priority Data
Jan. 13, 2023 (CN) 202310061765.5

(51) Int. Cl. C01B 32/05; H01M 10/054

(52) U.S. Cl. CPC C01B 32/05; H01M 10/054; C01P 2002/08; C01P 2002/72; C01P 2002/82; C01P 2004/03; C01P 2004/04; C01P 2006/12; C01P 2006/16; C01P 2006/40

(57) ABSTRACT

An anode material for a high-capacity sodium-ion battery, a preparation method thereof, and a battery are provided. The anode material comprises a porous carbon layer, in which a plurality of micropores are provided, the micropores of the porous carbon layer are filled with graphitic-layer-like carbon crystallites. The preparation method thereof comprises the steps of template-method-based deposition preparation of a porous carbon layer and heat treatment preparation of graphitic-layer-like carbon crystallites, etc. The anode material for a high-capacity sodium-ion battery, the preparation method thereof, and the battery have the characteristics of a large sodium storage capacity, a high initial Coulombic efficiency, a good cycle performance and an excellent rate performance.

### TECHNICAL FIELD

The present disclosure relates to the technical field of sodium-ion batteries, and in particular to an anode material for a high-capacity sodium-ion battery, a preparation method thereof, and a battery.

### BACKGROUND

The rapid development of new energy has greatly boosted the demand for large-scale energy storage technology. As a new type of secondary battery, sodium-ion batteries have attracted widespread attention in the field of large-scale energy storage due to their advantages such as abundant sodium resources and low cost. In a sodium-ion battery system, anode material is one of the key factors that determine battery performance. Therefore, in order to promote the industrialization of sodium-ion batteries, it is essential to develop anode materials that are high-performance, cost-effective, and easy to produce on a large scale. However, a hard carbon material, which is currently regarded as the most promising anode material, still faces many problems in practical applications, such as low sodium storage capacity, low initial Coulombic efficiency, and poor cycle stability.

In view of the above problems, Chinese invention patent CN114335523A discloses a preparation method for a hard carbon anode for a high-energy-density sodium-ion battery with excellent sodium storage performance, the hard carbon anode includes porous carbon and chemical vapor deposited carbon to regulate a surface pore size; and the hard carbon anode retains an internally continuous pore structure of the porous carbon. The invention designs a carbon-coated carbon-carbon composite structure via chemical vapor deposition to achieve control over a pore mouth size on the surface of porous carbon. In addition, combined with the effects of precursor particle size, specific surface area, pore size, precursor gas concentration, and catalysts on sodium storage performance, a hard carbon anode exhibiting excellent initial Coulombic efficiency, rate capability, and plateau capacity is designed, which has guiding significance for promoting the commercialization of high-energy-density sodium-ion batteries. Nevertheless, it should be noted that the hard carbon anode adopts a structure of deposited carbon-coated porous carbon particles, where an amount of deposited carbon, coating uniformity, deposition time, and deposition rate all have a significant impact on its performance, resulting in poor process controllability. Moreover, the pore size of the porous carbon has a range of 0.5-9 nm. Since the porous carbon is mainly amorphous carbon, its structural defects cause great fluctuations in size. Larger pore sizes will result in enhanced metallic properties of deposited sodium, increasing a risk of battery short circuits and reducing a specific surface area of the material, thereby reducing the sodium storage capacity of the material. Conversely, smaller pore sizes will affect ions transport in a solid phase, causing losses in rate performance and sodium storage capacity. Moreover, the sodium deposition potential in the pores is very close to a precipitation potential of metallic sodium. Therefore, during actual battery operation, sodium dendrites are easily generated due to polarization, resulting in short circuits and continuous capacity fading, which are detrimental to improving the battery safety and performance.

### SUMMARY

Objectives of the present disclosure are to provide an anode material for a high-capacity sodium-ion battery, a preparation method thereof, and a battery, which have the characteristics of large sodium storage capacity, high initial Coulombic efficiency, good cycle performance and excellent rate performance.

The present disclosure can be implemented through the following technical solutions:

The present disclosure discloses an anode material for a high-capacity sodium-ion battery, including porous carbon; a plurality of micropores are formed inside the porous carbon, and the micropores are filled with graphitic-layer-like carbon crystallites.

A charge-discharge curve of hard carbon consists of a high-potential slope region (>0.1 V vs. Na/Na⁺) and a low-voltage plateau region (<0.1 V vs. Na/Na⁺), and the latter is particularly important for an energy density of sodium-ion batteries. The sodium storage performance of hard carbon is closely related to its microstructure. A capacity of the low-potential plateau region mainly comes from the joint contribution of graphitic-layer-like carbon crystallites with appropriate interlayer spacing and micropores with suitable pore size in the hard carbon microstructure. Therefore, the present disclosure improves the capacity of the plateau region by increasing the graphitic-layer-like carbon crystallites with appropriate interlayer spacing and micropores with suitable pore size in the hard carbon microstructure, thereby increasing the energy density of the battery. Compared with the pore-forming strategies in the prior art, such as oxidizing carbon precursors, narrowing pore entrances, or using pore-forming agents (such as MgO particles, ethanol), the strategy of constructing graphitic-layer-like carbon crystallites filled in microporous structures provided in the present invention can effectively increase the sodium storage capacity of the hard carbon material, thereby improving the energy density of the battery.

Further, the porous carbon is microporous carbon and mesoporous carbon, with an average pore diameter of 0.4-4 nm, and a specific surface area of 1000-3000 m²/g.

Further, a volume of the graphitic-layer-like carbon crystallites filled in the porous carbon accounts for 50%-80% of a total pore volume of the porous carbon, and remaining unfilled pores are micropores. Compared with the prior art, graphitic-layer-like carbon crystallites alone have a higher sodium storage potential but a limited theoretical capacity (NaC₈, 279 mAh/g), while pore-based sodium storage alone may have a higher capacity upper limit, but the sodium storage potential is close to a precipitation potential of sodium metal, therefore, the battery is prone to sodium precipitation during the cycle, resulting in capacity fading and safety hazards. Therefore, the present disclosure compensates for the shortcomings of the aforesaid two methods by controlling a filling volume ratio of graphitic-layer-like carbon crystallite within the porous carbon, thereby making the hard carbon have both high sodium storage potential and high sodium storage capacity, and enabling safe and high-performance use of the battery.

Further, the filled graphitic-layer-like carbon crystallites have a pyrolytic carbon source of one or more of benzene, toluene, trimethylbenzene, acetylene, ethanol, formaldehyde, thiophene, pyridine, and/or thioether.

Another aspect of the present disclosure is to provide a preparation method of the above-mentioned anode material for a high-capacity sodium-ion battery, including the following steps:
step S1. preparation of filled carbon: porous carbon is used as a template, and placed in a high-temperature furnace; and an inert gas is introduced as an inert carrier gas to bring in a pyrolytic carbon source for heating treatment, and the filled carbon with pyrolytic carbon filled inside the porous carbon is prepared; and
step S2. high-temperature preparation of graphitic-layer-like carbon crystallites: the filled carbon obtained in the step S1 is placed in a tube furnace and subjected to heating treatment under an inert gas atmosphere, the pyrolytic carbon inside the porous carbon is graphitized and structurally ordered to form the graphitic-layer-like carbon crystallites, and the final anode material is obtained.

Further, in the step S1, the inert carrier gas is nitrogen and/or argon, a carrier gas flow rate is 20-300 Sccm, a heating rate is controlled at 1-20° C./min, a filling temperature is 600-1000° C., and filling time is 0.5-5 h. The above preparation conditions will affect the filling rate, filling depth, and filling amount of the graphitic-layer-like carbon crystallites. Specifically, increasing the carrier gas flow rate and filling temperature will accelerate the filling rate, and simultaneously reduce the filling depth and amount of graphitic-layer-like carbon crystallites within the pores of the porous carbon, resulting in a lower content of graphitic-layer-like carbon crystallites and a higher micropore volume of the filled carbon. A longer filling time increases the content of filled graphitic-layer-like carbon crystallites and reduces the volume of micropores. Therefore, comprehensive consideration will be given to the above preparation conditions to ensure that the material exhibits optimal performance.

Further, in the step S2, the inert carrier gas is nitrogen and/or argon, a heating rate is 1-10° C./min, a heat treatment temperature is 800-1600° C., and heat treatment time is 0.5-8 h. Similarly, the preparation conditions also influence a degree of graphitization of the hard carbon material. Specifically, a lower heating rate, a higher heat treatment temperature, and longer heat treatment time increase the content of graphitic-layer-like carbon crystallites in the hard carbon material. However, the conditions are not conducive to large-scale production in practice. Therefore, it is necessary to give comprehensive consideration to performance, cost, and energy consumption to determine better preparation conditions.

Another aspect of the present disclosure is to provide an anode sheet for a sodium-ion battery. Specifically, the anode sheet is prepared using the above-mentioned anode material.

Another aspect of the present disclosure is to provide a sodium-ion battery. Specifically, the sodium-ion battery is prepared using the above-mentioned anode material.

An anode material for a high-capacity sodium-ion battery, a preparation method thereof, and a battery provided in the present disclosure have the following beneficial effects:

The anode material of the present disclosure features controllable graphite nanodomains and pore structures, and can be used as an anode material for preparing an anode sheet for a sodium-ion battery or a sodium-ion battery, demonstrating an extremely high sodium storage capacity (430 mAh/g), a high initial Coulombic efficiency (88%), and good cycle stability (there is almost no capacity decay after 100 cycles at a current density of 50 mA/g, and a capacity retention is as high as 80% after 1000 cycles at the current density of 500 mA/g). Moreover, the anode material can effectively avoid the safety risks caused by sodium dendrites, and have obvious performance advantages.

### BRIEF DESCRIPTION OF THE DRAWINGS

FIG. 1 is an SEM image of a porous carbon template according to Application Example 3 of the present disclosure.

FIG. 2 is a TEM image of a porous carbon template according to Application Example 3 of the present disclosure.

FIG. 3 is XRD spectra of a porous carbon, a filled carbon, and a high-temperature graphitized filled carbon according to Application Example 3 of the present disclosure.

FIG. 4 is Raman spectra of a porous carbon, a filled carbon, and a high-temperature graphitized filled carbon according to Application Example 3 of the present disclosure.

FIG. 5 is an SEM image of a high-temperature graphitized filled carbon according to Application Example 3 of the present disclosure.

FIG. 6 is a TEM image of a high-temperature graphitized filled carbon according to Application Example 3 of the present disclosure.

FIG. 7 is a cycle performance diagram of a high-temperature graphitized filled carbon obtained in Application Example 3 at a current density of 50 mA/g.

FIG. 8 is a cycle performance diagram of a high-temperature graphitized filled carbon obtained in Application Example 3 at a current density of 500 mA/g.

FIG. 9 is a rate performance diagram of a high-temperature graphitized filled carbon according to Application Example 3 of the present disclosure.

### DETAILED DESCRIPTIONS OF THE EMBODIMENTS

In order to enable those skilled in the art to better understand the technical solutions of the present disclosure, the product in the present disclosure will be further described in detail below with reference to specific embodiments and accompanying drawings.

The present disclosure discloses an anode material for a high-capacity sodium-ion battery, including porous carbon; a plurality of micropores are formed inside the porous carbon, and the micropores are filled with graphitic-layer-like carbon crystallites.

Further, the porous carbon is microporous carbon and mesoporous carbon, with an average pore diameter of 0.4-4 nm, and a specific surface area of 1000-3000 m²/g.

Further, a volume of the graphitic-layer-like carbon crystallites filled in the porous carbon accounts for 50%-80% of a total pore volume of the porous carbon, and remaining unfilled pores are micropores.

Further, the filled graphitic-layer-like carbon crystallites have a pyrolytic carbon source of one or more of benzene, toluene, trimethylbenzene, acetylene, ethanol, formaldehyde, thiophene, pyridine, and/or thioether.

Another aspect of the present disclosure is to provide a preparation method of the above-mentioned anode material for a high-capacity sodium-ion battery, including the following steps:
step S1. preparation of filled carbon: porous carbon is used as a template, and placed in a high-temperature furnace; and an inert gas is introduced as an inert carrier gas to bring in a pyrolytic carbon source for heating treatment, and the filled carbon with pyrolytic carbon filled inside the porous carbon is prepared; and
step S2. high-temperature preparation of graphitic-layer-like carbon crystallites: the filled carbon obtained in the step S1 is placed in a tube furnace and subjected to heating treatment under an inert gas atmosphere, the pyrolytic carbon inside the porous carbon is graphitized and structurally ordered to form the graphitic-layer-like carbon crystallites, and the final anode material is obtained.

Further, in the step S1, the inert carrier gas is nitrogen and/or argon, a carrier gas flow rate is 20-300 Sccm, a heating rate is controlled at 1-20° C./min, a filling temperature is 600-1000° C., and filling time is 0.5-5 h.

Further, in the step S2, the inert carrier gas is nitrogen and/or argon, a heating rate is 1-10° C./min, a heat treatment temperature is 800-1600° C., and heat treatment time is 1-8 h.

Another aspect of the present disclosure is to provide an anode sheet for a sodium-ion battery. Specifically, the anode sheet is prepared using the above-mentioned anode material.

Another aspect of the present disclosure is to provide a sodium-ion battery. Specifically, the sodium-ion battery is prepared using the above-mentioned anode material.

### Example 1

This Example discloses an anode material for a high-capacity sodium-ion battery, including porous carbon; a plurality of micropores are formed inside the porous carbon, and the micropores are filled with graphitic-layer-like carbon crystallites.

In this embodiment, the porous carbon is microporous carbon and mesoporous carbon, with an average pore diameter of 0.4-4 nm, and a specific surface area of 1000-3000 m²/g. A volume of the graphitic-layer-like carbon crystallites filled in the porous carbon accounts for 50%-80% of a total pore volume of the porous carbon, and remaining unfilled pores are micropores.

Specifically, the filled graphitic-layer-like carbon crystallites have pyrolytic carbon sources, such as benzene, toluene and trimethylbenzene.

### Example 2

This Example discloses an anode material for a high-capacity sodium-ion battery, including porous carbon; a plurality of micropores are formed inside the porous carbon, and the micropores are filled with graphitic-layer-like carbon crystallites.

In this embodiment, the porous carbon is microporous carbon and mesoporous carbon, with an average pore diameter of 0.4-4 nm, and a specific surface area of 1000-3000 m²/g. A volume of the graphitic-layer-like carbon crystallites filled in the porous carbon accounts for 50%-80% of a total pore volume of the porous carbon, and remaining unfilled pores are micropores.

Specifically, the filled graphitic-layer-like carbon crystallites have pyrolytic carbon sources, such as acetylene, ethanol, formaldehyde, thiophene, pyridine, and thioether.

### Example 3

This Example discloses an anode material for a high-capacity sodium-ion battery, including porous carbon; a plurality of micropores are formed inside the porous carbon, and the micropores are filled with graphitic-layer-like carbon crystallites.

In this embodiment, the porous carbon is microporous carbon and mesoporous carbon, with an average pore diameter of 0.4-4 nm, and a specific surface area of 1000-3000 m²/g. A volume of the graphitic-layer-like carbon crystallites filled in the porous carbon accounts for 50%-80% of a total pore volume of the porous carbon, and remaining unfilled pores are micropores.

Specifically, the filled graphitic-layer-like carbon crystallites have pyrolytic carbon sources, such as benzene, toluene, formaldehyde, thiophene, and pyridine.

### Example 4

The anode material for a high-capacity sodium-ion battery of Examples 1-3 can be prepared by the following preparation method:
step S1. preparation of filled carbon: porous carbon is used as a template, and placed in a high-temperature furnace; and an inert gas is introduced as an inert carrier gas to bring in a pyrolytic carbon source for heating treatment, and the filled carbon with pyrolytic carbon filled inside the porous carbon is prepared; and
step S2. high-temperature preparation of graphitic-layer-like carbon crystallites: the filled carbon obtained in the step S1 is placed in a tube furnace and subjected to heating treatment under an inert gas atmosphere, the pyrolytic carbon inside the porous carbon is graphitized and structurally ordered to form the graphitic-layer-like carbon crystallites, and the final anode material is obtained.

Specifically, in the step S1, the inert carrier gas was nitrogen and argon, a carrier gas flow rate was 300 Sccm, a heating rate was controlled at 10° C./min, a filling temperature was 600° C., and filling time was 5 h.

Specifically, in the step S2, the inert carrier gas was nitrogen and argon, a heating rate was 10° C./min, a heat treatment temperature was 1300° C., and heat treatment time was 1 h.

### Example 5

The anode material for a high-capacity sodium-ion battery of Examples 1-3 can be prepared by the following preparation method:
step S1. preparation of filled carbon: porous carbon is used as a template, and placed in a high-temperature furnace; and an inert gas is introduced as an inert carrier gas to bring in a pyrolytic carbon source for heating treatment, and the filled carbon with pyrolytic carbon filled inside the porous carbon is prepared; and
step S2. high-temperature preparation of graphitic-layer-like carbon crystallites: the filled carbon obtained in the step S1 is placed in a tube furnace and subjected to heating treatment under an inert gas atmosphere, the pyrolytic carbon inside the porous carbon is graphitized and structurally ordered to form the graphitic-layer-like carbon crystallites, and the final anode material is obtained.

Specifically, in the step S1, the inert carrier gas was nitrogen, a carrier gas flow rate was 200 Sccm, a heating rate was controlled at 2° C./min, a filling temperature was 1000° C., and filling time was 3 h.

Specifically, in the step S2, the inert carrier gas was nitrogen and/or argon, a heating rate was 5° C./min, a heat treatment temperature was 1100° C., and heat treatment time was 8 h.

### Example 6

The anode material for a high-capacity sodium-ion battery of Examples 1-3 can be prepared by the following preparation method:
step S1. preparation of filled carbon: porous carbon is used as a template, and placed in a high-temperature furnace; and an inert gas is introduced as an inert carrier gas to bring in a pyrolytic carbon source for heating treatment, and the filled carbon with pyrolytic carbon filled inside the porous carbon is prepared; and
step S2. high-temperature preparation of graphitic-layer-like carbon crystallites: the filled carbon obtained in the step S1 is placed in a tube furnace and subjected to heating treatment under an inert gas atmosphere, the pyrolytic carbon inside the porous carbon is graphitized and structurally ordered to form the graphitic-layer-like carbon crystallites, and the final anode material is obtained.

Specifically, in the step S1, the inert carrier gas was nitrogen, a carrier gas flow rate was 20 Sccm, a heating rate was controlled at 20° C./min, a filling temperature was 800° C., and filling time was 0.5 h.

Specifically, in the step S2, the inert carrier gas was nitrogen, a heating rate was 2° C./min, a heat treatment temperature was 1600° C., and heat treatment time was 4 h.

### Example 7

The anode material for a high-capacity sodium-ion battery of Examples 1-3 can be prepared by the following preparation method:
step S1. preparation of filled carbon: porous carbon is used as a template, and placed in a high-temperature furnace; and an inert gas is introduced as an inert carrier gas to bring in a pyrolytic carbon source for heating treatment, and the filled carbon with pyrolytic carbon filled inside the porous carbon is prepared; and
step S2. high-temperature preparation of graphitic-layer-like carbon crystallites: the filled carbon obtained in the step S1 is placed in a tube furnace and subjected to heating treatment under an inert gas atmosphere, the pyrolytic carbon inside the porous carbon is graphitized and structurally ordered to form the graphitic-layer-like carbon crystallites, and the final anode material is obtained.

Specifically, in the step S1, the inert carrier gas was nitrogen and argon, a carrier gas flow rate was 160 Sccm, a heating rate was controlled at 10° C./min, a filling temperature was 800° C., and filling time was 3 h.

Specifically, in the step S2, the inert carrier gas was nitrogen and argon, a heating rate was 4° C./min, a heat treatment temperature was 1200° C., and heat treatment time was 6 h.

### Application Example 1

This Application Example provides an anode sheet for a sodium-ion battery. Specifically, the anode sheet is prepared using the above-mentioned anode material.

### Application Example 2

This Application Example provides a sodium-ion battery. Specifically, the sodium-ion battery is prepared using the above-mentioned anode material.

### Application Example 3

This Application Example discloses an anode material for a high-capacity sodium-ion battery, including porous carbon; a plurality of micropores are formed inside the porous carbon, and the micropores are filled with graphitic-layer-like carbon crystallites. with steps for preparation and test thereof as follows:
S11: Activated carbon was placed in a tube furnace, and nitrogen gas was introduced at a flow rate of 100 Sccm, and the nitrogen was used a carrier gas to bring in benzene vapor.

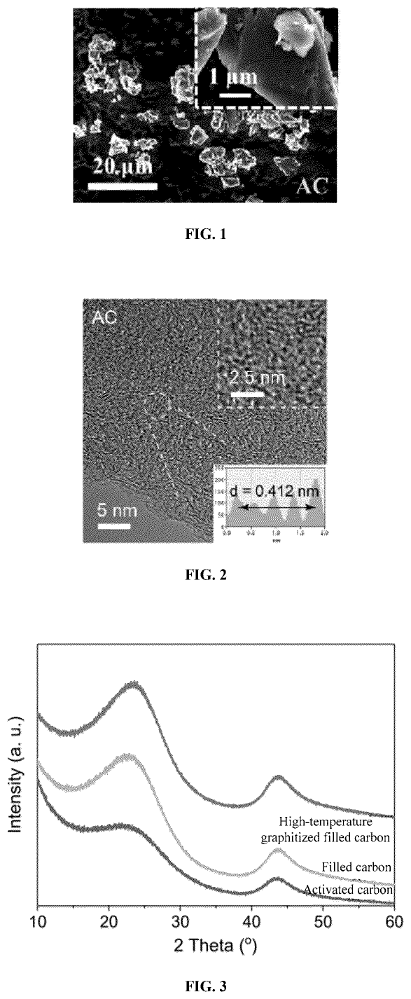

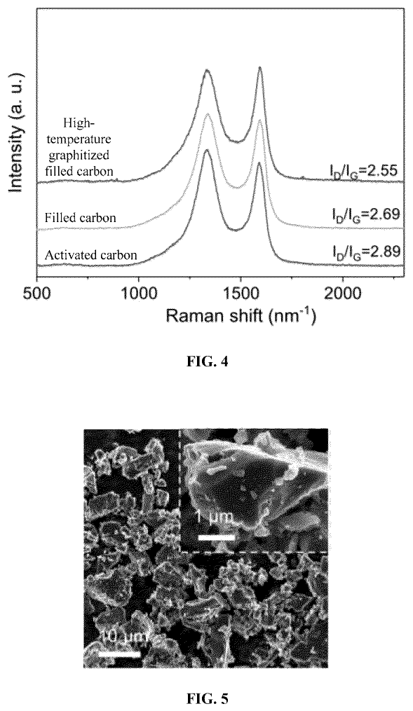

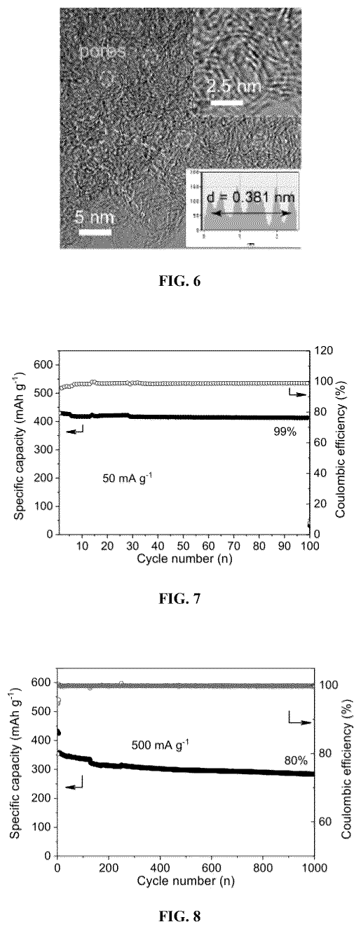

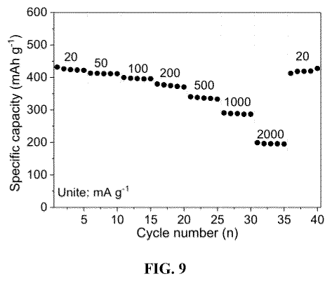

Specifically, the activated carbon used in the step S11 was commercial activated carbon YEC-8A, with a specific surface area of 1600 m²/g and an average pore diameter of 0.9 nm. A measured true density was 2.16 cm³/g. FIG. 1 is an SEM image of a porous carbon template according to Application Example 3 of the present disclosure. FIG. 2 is a TEM image of a porous carbon template according to Application Example 3 of the present disclosure. The TEM images indicate that there were almost no graphitic-layer-like carbon crystallite regions in an activated carbon template. XRD and Raman spectra of the activated carbon are shown in FIGS. 3 and 4, respectively.
S12: The temperature was raised to 700° C. at a heating rate of 5° C./min, and the temperature was naturally cooled to room temperature after being kept constant for 3 h. A measured true density was 1.80 cm³/g, indicating that internal pores were formed within the filled carbon, resulting in a decrease in the true density. XRD and Raman spectra of the high-temperature graphitized filled carbon are shown in FIGS. 3 and 4, respectively.
S13: The filled carbon obtained in the step S12 was placed in a tube furnace and heated to 1300° C. at a heating rate of 5° C./min under a nitrogen atmosphere, and the temperature was cooled at a cooling rate of 5° C./min to room temperature after being kept constant for 2 h. The filled carbon was further graphitized to obtain a high-temperature graphitized filled carbon. FIG. 3 is XRD spectra of a porous carbon, a filled carbon, and a high-temperature graphitized filled carbon according to Application Example 3 of the present disclosure. FIG. 4 is Raman spectra of a porous carbon, a filled carbon, and a high-temperature graphitized filled carbon according to Application Example 3 of the present disclosure. FIG. 5 is an SEM image of a high-temperature graphitized filled carbon according to Application Example 3 of the present disclosure. FIG. 6 is a TEM image of a high-temperature graphitized filled carbon according to Application Example 3 of the present disclosure. The TEM images show that a large number of graphitic-layer-like carbon crystallite regions were introduced into the activated carbon template, and there were also a large number of microporous regions. Full widths at half maximum (FWHM) in the XRD spectra of the porous carbon, the filled carbon, and the high-temperature graphitized filled carbon decrease in turn, and Ip/IG in the Raman spectra also decrease in turn, indicating that a degree of graphitization of the material increased, and sizes of the graphitic-layer-like carbon crystallite also increased, which further demonstrates that the graphitic-layer-like carbon crystallites were filled into the pores of the activated porous carbon.
S14: The activated carbon, the filled carbon obtained in the step S12, and the high-temperature graphitized filled carbon obtained in the step S13 were subjected to nitrogen adsorption-desorption, and helium true density measurement, open pore volumes and closed pore volumes of the corresponding materials were obtained through calculation, and total pore volumes were accordingly obtained. The total pore volumes of the activated carbon, the filled carbon, and the high-temperature graphitized filled carbon were 0.86 cm³/g, 0.18 cm³/g, and 0.24 cm³/g, respectively, indicating that some pores were filled with graphitic-layer-like carbon crystallites, but others remained unfilled and retained.
S15: The high-temperature graphitized filled carbon obtained in the step S13 was used as an active material, carboxymethyl cellulose (CMC) and styrene-butadiene rubber (SBR) were used as binders, and Super P (SP) was used as conductive carbon; a slurry was prepared with a ratio of the active material: CMC:SBR:SP=95:1.5:2:1.5 for coating a film; after dried, the film was sliced and assembled into a 2032 button battery in a glove box; and cycle performance was tested using Neware software. FIG. 7 is a cycle performance diagram of a high-temperature graphitized filled carbon obtained in Application Example 3 at a current density of 50 mA/g. FIG. 8 is a cycle performance diagram of a high-temperature graphitized filled carbon obtained in Application Example 3 at a current density of 500 mA/g. FIG. 9 is a rate performance diagram of a high-temperature graphitized filled carbon according to Application Example 3 of the present disclosure. As can be seen from the figures, the obtained material exhibited extremely high sodium storage capacity (430 mAh/g) and high initial Coulombic efficiency (88%). It demonstrated good cycle performance, with almost no capacity decay after 100 cycles at a current density of 50 mA/g (FIG. 7), and a capacity retention was as high as 80% after 1000 cycles at the current density of 500 mA/g (FIG. 8). It also showed good rate performance, maintaining a capacity of 290.7 mAh/g at a current density of 1 A/g (FIG. 9). The overall sodium storage performance of the material ranks at the forefront among hard carbon materials. Compared with the preparation method disclosed in Chinese patent CN114335523A, the method in the present disclosure has better control over the amount, uniformity, and consistency of deposited carbon. Moreover, compared with sodium storage via pore deposition, sodium storage via intercalation between graphite-like microcrystalline layers has a higher sodium storage potential, which reduces the problem of battery short circuits and capacity fading caused by sodium metal deposition during battery use, and is more conducive to the commercial application of hard carbon anode materials for sodium-ion batteries.

### Application Example 4

This Application Example discloses an anode material for a high-capacity sodium-ion battery, including porous carbon; a plurality of micropores are formed inside the porous carbon, and the micropores are filled with graphitic-layer-like carbon crystallites. with steps for preparation and test thereof as follows:
S11: Porous carbon was placed in a tube furnace, and nitrogen gas was introduced at a flow rate of 100 Sccm, and the nitrogen was used a carrier gas to bring in pyridine vapor.

Specifically, the activated carbon used in the step S11 was commercial activated carbon YEC-8A, with a specific surface area of 1600 m²/g and an average pore diameter of 0.9 nm. A measured true density was 2.16 cm³/g.
S12: The temperature was raised to 700° C. at a heating rate of 5° C./min, and the temperature was naturally cooled to room temperature after being kept constant for 3 h.
S13: The filled carbon obtained in the step S12 was placed in a tube furnace and heated to 1300° C. at a heating rate of 5° C./min under a nitrogen atmosphere, and the temperature was cooled at a cooling rate of 5° C./min to room temperature after being kept constant for 2 h. The filled carbon was further graphitized to obtain a high-temperature graphitized filled carbon.
S14: The high-temperature graphitized filled carbon obtained in the step S13 was used as an active material, carboxymethyl cellulose (CMC) and styrene-butadiene rubber (SBR) were used as binders, and Super P (SP) was used as conductive carbon; a slurry was prepared with a ratio of the active material: CMC:SBR:SP=95:1.5:2:1.5 for coating a film; after dried, the film was sliced and assembled into a 2032 button battery in a glove box; and cycle performance was tested using Neware software.

### Application Example 5

This Application Example discloses an anode material for a high-capacity sodium-ion battery, including porous carbon; a plurality of micropores are formed inside the porous carbon, and the micropores are filled with graphitic-layer-like carbon crystallites. with steps for preparation and test thereof as follows:
S11: Activated carbon was placed in a tube furnace, and nitrogen gas was introduced at a flow rate of 100 Sccm, and the nitrogen was used a carrier gas to bring in thiophene vapor.

Specifically, the activated carbon used in the step S11 was commercial activated carbon YEC-8A, with a specific surface area of 1600 m²/g and an average pore diameter of 0.9 nm. A measured true density was 2.16 cm³/g.
S12: The temperature was raised to 700° C. at a heating rate of 5° C./min, and the temperature was naturally cooled to room temperature after being kept constant for 3 h.
S13: The filled carbon obtained in the step S12 was placed in a tube furnace and heated to 1300° C. at a heating rate of 5° C./min under a nitrogen atmosphere, and the temperature was cooled at a cooling rate of 5° C./min to room temperature after being kept constant for 2 h. The filled carbon was further graphitized to obtain a high-temperature graphitized filled carbon.
S14: The high-temperature graphitized filled carbon obtained in the step S13 was used as an active material, carboxymethyl cellulose (CMC) and styrene-butadiene rubber (SBR) were used as binders, and Super P (SP) was used as conductive carbon; a slurry was prepared with a ratio of the active material: CMC:SBR:SP=95:1.5:2:1.5 for coating a film; after dried, the film was sliced and assembled into a 2032 button battery in a glove box; and cycle performance was tested using Neware software.

### Application Example 6

This Application Example discloses an anode material for a high-capacity sodium-ion battery, including porous carbon; a plurality of micropores are formed inside the porous carbon, and the micropores are filled with graphitic-layer-like carbon crystallites. with steps for preparation and test thereof as follows:
S11: Porous carbon was placed in a tube furnace, and acetylene gas was introduced at a flow rate of 100 Sccm.

Specifically, the activated carbon used in the step S11 was commercial activated carbon YEC-8A, with a specific surface area of 1600 m²/g and an average pore diameter of 0.9 nm. A measured true density was 2.16 cm³/g.
S12: The temperature was raised to 700° C. at a heating rate of 5° C./min, and the temperature was naturally cooled to room temperature after being kept constant for 3 h.
S13: The filled carbon obtained in the step S12 was placed in a tube furnace and heated to 1300° C. at a heating rate of 5° C./min under a nitrogen atmosphere, and the temperature was cooled at a cooling rate of 5° C./min to room temperature after being kept constant for 2 h. The filled carbon was further graphitized to obtain a high-temperature graphitized filled carbon.
S14: The high-temperature graphitized filled carbon obtained in the step S13 was used as an active material, carboxymethyl cellulose (CMC) and styrene-butadiene rubber (SBR) were used as binders, and Super P (SP) was used as conductive carbon; a slurry was prepared with a ratio of the active material: CMC:SBR:SP=95:1.5:2:1.5 for coating a film; after dried, the film was sliced and assembled into a 2032 button battery in a glove box; and cycle performance was tested using Neware software.

The embodiments mentioned above are merely several embodiments of the present disclosure, and are specifically described in details, but cannot be interpreted as limiting the scope of the patent for the present disclosure as a result. It shall be noted that for those of ordinarily skilled in the art, they may make several transformations and improvements on the premise without deviating from concepts of the present disclosure, these transformations and improvements should be considered to fall within the protection scope of the present disclosure.

What is claimed is:

1. An anode material for a high-capacity sodium-ion battery, comprising porous carbon, wherein a plurality of micropores are formed inside the porous carbon, and the micropores are filled with graphitic-layer-like carbon crystallites.

2. The anode material for a high-capacity sodium-ion battery according to claim 1, wherein the porous carbon is microporous carbon and mesoporous carbon having an average pore diameter of 0.4-4 nm, and a specific surface area of 1000-3000 m²/g.

3. The anode material for a high-capacity sodium-ion battery according to claim 2, wherein a volume of the graphitic-layer-like carbon crystallites filled in the porous carbon accounts for 50%-80% of a total pore volume of the porous carbon, and remaining unfilled pores are micropores.

4. The anode material for a high-capacity sodium-ion battery according to claim 3, wherein the filled graphitic-layer-like carbon crystallites have a pyrolytic carbon source of one or more of benzene, toluene, trimethylbenzene, acetylene, ethanol, formaldehyde, thiophene, pyridine, and/or thioether.

5. A preparation method of the anode material for a high-capacity sodium-ion battery of claim 1, comprising the following steps:
step S1. preparing filled carbon: using porous carbon as a template, placing the porous carbon in a high-temperature furnace, and introducing an inert gas as an inert carrier gas to bring in a pyrolytic carbon source for heating treatment to prepare and obtain the filled carbon with pyrolytic carbon filled inside the porous carbon; and
step S2. preparing graphitic-layer-like carbon crystallites at a high temperature: placing the filled carbon obtained in the step S1 in a tube furnace and performing heating treatment under an inert gas atmosphere, graphitizing the pyrolytic carbon inside the porous carbon for structural ordering to form the graphitic-layer-like carbon crystallites, and obtaining the final anode material.

6. The preparation method of the anode material for a high-capacity sodium-ion battery according to claim 5, wherein in the step S1, the inert carrier gas is nitrogen and/or argon, a carrier gas flow rate is 20-300 Sccm, a heating rate is controlled at 1-20° C./min, a filling temperature is 600-1000° C., and filling time is 0.5-5 h.

7. The preparation method of the anode material for a high-capacity sodium-ion battery according to claim 5, wherein in the step S2, the inert carrier gas is nitrogen and/or argon, a heating rate is 1-10° C./min, a heat treatment temperature is 800-1600° C., and heat treatment time is 0.5-8 h.

8. An anode sheet for a sodium-ion battery, wherein the anode sheet is prepared using the anode material for a high-capacity sodium-ion battery of claim 1.

9. A sodium-ion battery, wherein the sodium-ion battery is prepared using the anode material for a high-capacity sodium-ion battery of claim 1.
